(19) United States
(12) Patent Application Publication
(10) Pub. No.: US 2016/0070253 A1
(43) Pub. Date: Mar. 10, 2016

(54) MONITORING HOLE MACHINING

(71) Applicant: Rolls-Royce Corporation, Indianapolis, IN (US)

(72) Inventors: Mike R. Dunkin, Carmel, IN (US); Michael George Glavicic, Indianapolis, IN (US); Kong Ma, Carmel, IN (US); Andrew James Ritchey, Lafayette, IN (US)

(73) Assignee: Rolls-Royce Corporation

(21) Appl. No.: 14/843,257

(22) Filed: Sep. 2, 2015

Related U.S. Application Data
(60) Provisional application No. 62/046,558, filed on Sep. 5, 2014.

(51) Int. Cl. G05B 19/406; B23B 41/16

(52) U.S. Cl. CPC G05B 19/406; B23B 41/16; B23B 2270/483; B23Q 17/0961

(57) ABSTRACT

A method includes machining a component with a machine tool to form a feature in the component, monitoring, by a computing device, while machining the feature into the component with the machine tool, horsepower of the machine tool used to machine the component, determining, by the computing device, a quality of the feature in the component based on the monitored horsepower, and storing, by the computing device, an indication of the quality of the feature in combination with a unique identifier for the feature in a non-transitory computer-readable medium.

This application claims the benefit of U.S. Provisional Patent Application No. 62/046,558, filed Sep. 5, 2014, which is incorporated by reference in its entirety.

### TECHNICAL FIELD

The invention relates to machining and evaluation of machined surfaces.

### BACKGROUND

The quality of machined features within metal components may vary even when a series of components is manufactured using the same equipment according to the same design and specifications. For example, the finish quality of machined surfaces may vary. Machining may cause sonic features to have damage, such as white layer damage. White layer is a layer of untempered metal on the surface, which resists etching and appears white on a micrograph after etching a sample. Machined components may be manually inspected after machining for quality and damage such as while layer damage.

### SUMMARY

This disclosure is directed to techniques for evaluating the quality of machined components. In some examples, the machine tooling force may be monitored during machining to evaluate the quality of a machined component. For example, a higher tooling force may indicate white layer damage. In the same or different examples, the quality of a machined component may be automatically evaluated by an imagining system. In some particular examples, machined features with a component may be designated for follow-up inspection based on tooling forces monitored during the machining of those features.

In one example, this disclosure is directed to a method comprising machining a component with a machine tool to form a feature in the component, monitoring, by a computing device, while machining the feature into the component with the machine tool, horsepower of the machine tool used to machine the component, determining, by the computing device, a quality of the feature in the component based on the monitored horsepower, and storing, by the computing device, an indication of the quality of the feature in combination with a unique identifier for the feature in a non-transitory computer-readable medium.

In another example, this disclosure is directed to a system comprising a machine tool, and a computing device. The computing device is configured to send control signals to the machine tool for causing the machine tool to machine a component to form a feature in the component, monitor, while the machine tool machines the feature into the component, horsepower of the machine tool used to machine the component, determine a quality of the feature in the component based on the monitored horsepower, and store an indication of the quality of the feature in combination with a unique identifier for the feature in a non-transitory computer-readable medium.

In a further example, this disclosure is directed to a non-transitory computer-readable data storage medium having instructions stored thereon that, when executed by one or more processors of a computing device, cause the computing device to send control signals to a machine tool for causing the machine tool to machine a component to form a feature in the component, monitor, while the machine tool machines the feature into the component, horsepower of the machine tool used to machine the component, determine a quality of the feature in the component based on the monitored horsepower, and store an indication of the quality of the feature in combination with a unique identifier for the feature in a non-transitory computer-readable medium.

In another example, this disclosure is directed to a method comprising obtaining an image of a feature machined in a component with an imaging device, determining, by a computing device, a quality of the feature in the component based on the image of the feature, and storing, by the computing device, an indication of the quality of the feature in combination with a unique identifier for the feature in a non-transitory computer-readable medium.

In a further example, this disclosure is directed to a system for evaluating a quality of a feature machined in a component, the system comprising an imaging device, and a computing device. The computing device is configured to send control signals for causing the imaging device to capture an image of a feature machined in a component, determine a quality of the feature in the component based on the image of the feature, and store an indication of the quality of the feature in combination with a unique identifier for the feature in a non-transitory computer-readable medium.

In another example, this disclosure is directed to a non-transitory computer-readable data storage medium having instructions stored thereon that, when executed by one or more processors of a computing device, cause the computing device to send control signals to an imaging device for causing imaging device to capture an image of a feature machined in a component, determine a quality of the feature in the component based on the image of the feature, and store an indication of the quality of the feature in combination with a unique identifier for the feature in a non-transitory computer-readable medium.

The details of one or more examples of this disclosure are set forth in the accompanying drawings and the description below. Other features, objects, and advantages of this disclosure will be apparent from the description and drawings, and from the claims.

### BRIEF DESCRIPTION OF DRAWINGS

FIG. 1 illustrates a machined hole in a component, the machined hole exhibiting white layer damage.

FIG. 2 is a close-up of a cross section of a machined surface of a component and illustrates a swept grain layer as well as a white layer from the machining of the component.

FIG. 3 illustrates a system including a machine tool and a computing device configured to determine a quality of a feature machined by the machine tool based on monitored horsepower of the machine tool.

FIG. 4 is a flowchart illustrating example techniques for determining a quality of a machined feature in a component based on monitored horsepower.

FIGS. 5A-7B illustrate monitored horsepower and cooling fluid flow rates during the machining of different holes in combination with the machined holes.

FIG. 8 illustrates a system including an imagining device and a computing device configured to determine a quality of a machined feature in a component based on an image of the component.

FIGS. 9A and 9B illustrate an example series of images that facilitate Principal Component Analysis of an image of a machined feature in a component to determine a quality of a machined feature based on the image.

FIG. 10 is a flowchart illustrating example techniques for determining a quality of the machined feature in a component based monitored machining parameters and an image of the component.

### DETAILED DESCRIPTION

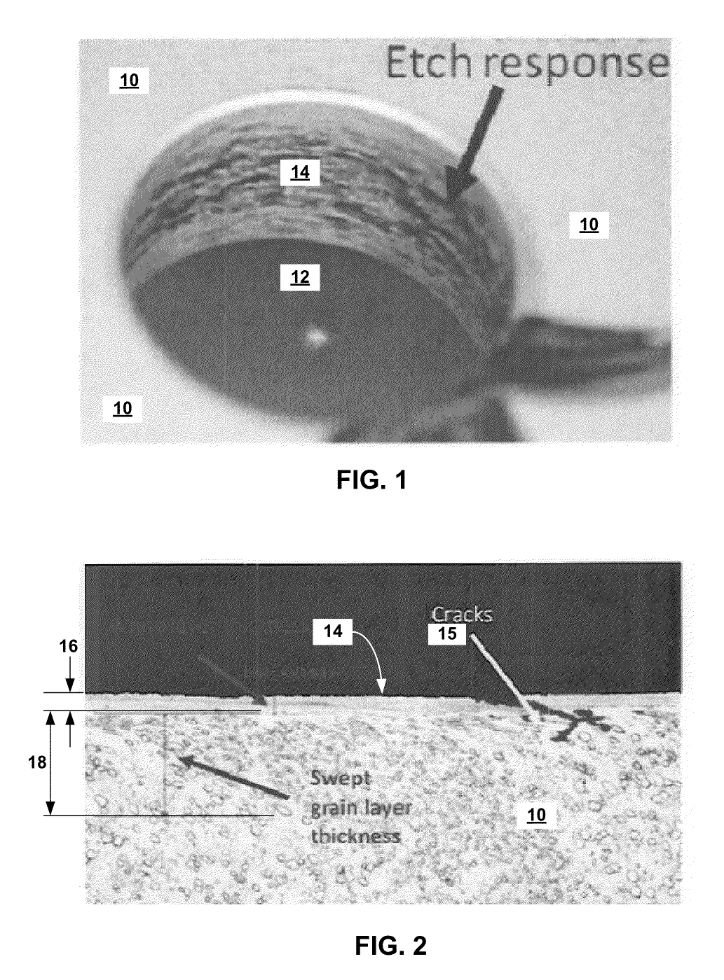

FIG. 1 illustrates component 10 with machined hole 12. Surface 14 of machined hole 12 has been subjected to etching. As shown in FIG. 1, the etching has made white layer damage from the machining of machined hole 12 visible on surface 14.

FIG. 2 is a close-up of a cross section of a machined surface 14 of component 10. Surface 14 was created from a machining operation, such as drilling, milling, turning or other machining operation. The machining operation created white layer 16 as well as swept grain layer 18. Surface 14, further includes cracks 15, which are also the result of the high stresses of the machining operation that created white layer 16. For example, white layer 16 is relatively brittle as compared to the rest of component 10, and cracks 15 may have propagated from smaller cracks in white layer 16.

During manufacturing, surface damage such as that illustrated in FIGS. 1 and 2 is generally undesirable. White layer damage is generally understood to be the result of an abusive interaction between a cutting element of a machine tool and the workpiece. Surface defects, such as white layer 16 and cracks 15 may be a major life determining factors for manufactured components because machining-induced surface damage has a very brittle nature and usually carries tensile residual stress. As demonstrated by FIG. 1, etching in an acidic bath followed by visual inspection of machined surfaces can be used to detect such surface defects. Following etching, machining defects present as lightly colored regions in contrast to the surrounding parent material.

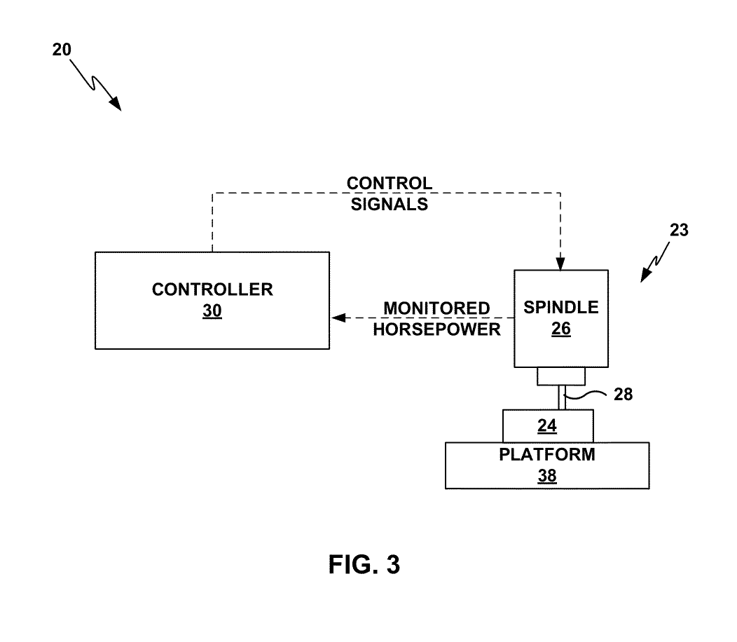

As described herein, a surface quality of a machined feature may also be determined based on monitoring horsepower of a machine tool used to form the feature during the machining of the feature, for example, using a system such as system 20 of FIG. 3. System 20 includes machine tool 23 and controller 30, a computing device.

Machine tool 23 is configured to perform a machining operation on workpiece 24 with spindle 26 and cutting element 28. In one example, machine tool 23 may represent a computer numerical control (CNC) machine capable of performing routing, turning, drilling and/or other machining operations. Workpiece 24 is mounted to platform 38 in a manner that facilitates precise machining of workpiece 24 by machine tool 23. While the techniques disclosed herein may apply to workpieces of any materials, workpiece

24 may be metal subject to machining damage, including white layer damage.

Controller 30 represents a computing device configured to operate machine tool 23. In some examples, controller may be configured to adaptively machine workpiece 24 based on real-time or near real-time feedback of operational parameters associated with the operation of machine tool 23, such as one or more of horsepower of spindle 26, coolant pressure, coolant flowrate, cutting element vibration, and/or feed force of machine tool 23. Controller 30 may further be configured to determine a quality of a feature machined by machine tool 23 in workpiece 24 based on monitored horsepower of spindle 26 of machine tool 23.

In one particular example, controller 30 may operate to adjust the feed rate of spindle 26 and/or rotational speed of spindle 26 based on the monitored operational parameters in order to keep the monitored operational parameters within predefined limits. For example, controller 30 may operate to adjust the feed rate of spindle 26 and/or rotational speed of spindle 26 to prevent the monitored horsepower of spindle 26 from exceeding a predefined limit.

Machine tool 23 is configured to machine the component to form the feature in the component in response to the control signals sent from controller 30. In some examples, machine tool 23 may be configured to drill, mill or turn features into workpiece 24. For example, machine tool 23 may be configured to drill a through hole into workpiece 24 with spindle 26 or other rotary element.

In some particular examples, controller 30 may include multiple computing devices that combine to provide the functionality of controller 30 as described herein. For example, controller 30 may comprise a CNC controller that issues instructions to spindle 26 and positioning actuators of machine tool 23 as well as a separate computing device that monitors operational parameters of machine tool 23 and actively adjust the feed rate of spindle 26 and/or rotational speed of spindle 26 based on the monitored parameters. In some examples, such a computing device may represent a general purpose computer running software. Software suitable for actively controlling machining parameters includes Tool Monitor Adaptive Control (TMAC) software from Caron Engineering of Wells, Me., United States.

Control signals from controller 30 for causing machine tool 23 to machine workpiece 24 may be based on a predetermined design of the feature and the monitored horsepower. In some examples, controller 30 evaluates monitored horsepower of spindle 26 against predetermined static thresholds. A computing device of controller 30 may then update the machining variables, such as the feed rate of spindle 26 and/or rotational speed of spindle 26, in real time and populates them to a CNC controller of controller 30 to adjust the feed rate of spindle 26 and/or rotational speed of spindle 26 in an effort to maintain spindle horsepower below a predetermined static thresholds or even maintain a relatively constant spindle horsepower.

In further examples, controller 30 may further monitor one or more of coolant pressure, coolant flowrate, cutting element vibration, and feed force of machine tool 23. In the same or different examples, controller 30 may apply preset processing thresholds for one or more of the monitored machining variables and maintain operations within the preset thresholds, for example, by varying a rotational velocity and/or linear velocity of cutting element 28 is real-time. Such preset processing thresholds may improve tooling life and provide reduce residual stresses due to machining operations.

In addition, by monitoring horsepower of spindle 26, and potentially other machining variables, such as one or more of coolant pressure, coolant flowrate, cutting element vibration, and feed force of machine tool 23, controller 30 further facilitates determining a quality of a feature machined by machine tool 23 in workpiece 24. For example, controller 30 may assess monitored horsepower of spindle 26 by evaluating overall maximum horsepower, variation between maximum and minimum horsepower, along with frequency of horsepower variation. In this manner, controller 30 may operate to identify machined features that are likely to have white layer damage or other quality issues automatically based on monitored horsepower of spindle 26, and potentially other machining variables, during the machining of such features.

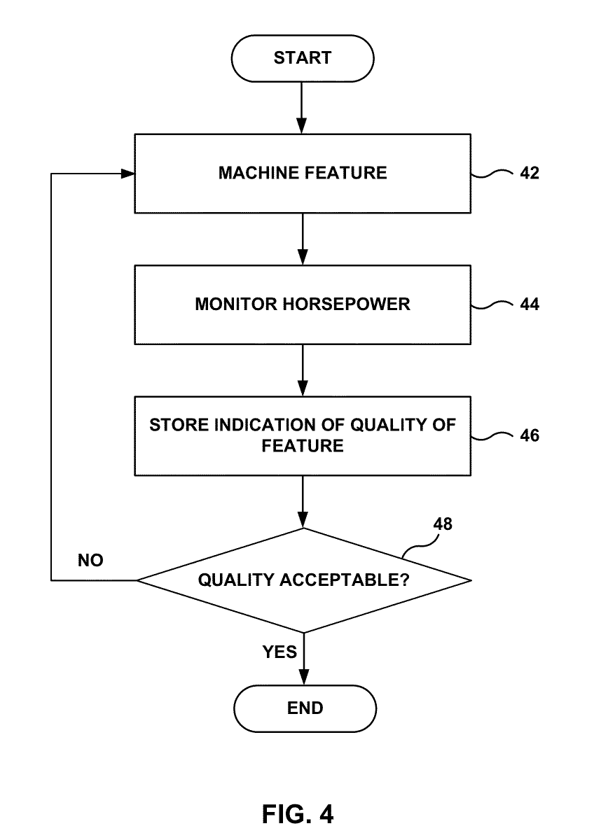

As discussed in further detail with respect to FIG. 4, controller 30 may flag features in which a determined quality is outside of specifications for further evaluation and/or a secondary rework operation to improve a surface quality of the machined feature. In some examples, a machined feature may be automatically subjected to a secondary rework operation before workpiece 24 is removed from platform 38.

In this manner, system 20 facilitates pre-inspection and a secondary rework operation of a feature prior to removal of workpiece 24 from platform 38. This may speed the manufacture of a component from workpiece 24 as compared to techniques in which workpiece 24 is only inspected after removal from platform 38. In addition, the ability of pre-inspecting features may result in improved surface quality of machined features within workpiece 24 such that fewer defects may be found during a subsequent visual inspection. In addition, system 20 provides improved confidence in the integrity of a machined component as a surface quality of the machined feature may be determined based on both monitored horsepower of spindle 26 as well as a later visual inspection.

FIG. 4 is a flowchart illustrating example techniques for determining a quality of a machined feature in a component based on monitored horsepower. For clarity, the techniques of FIG. 4 are described with respect to system 20 of FIG. 3.

Workpiece 24 is mounted to platform 38, and controller 30 initiates a machining operation with machine tool 23 on workpiece 24 to form a feature in workpiece 24 (42). During the machining of the feature into workpiece 24, controller 30 monitors horsepower of machine tool 23, such as the horsepower of spindle 26 (44).

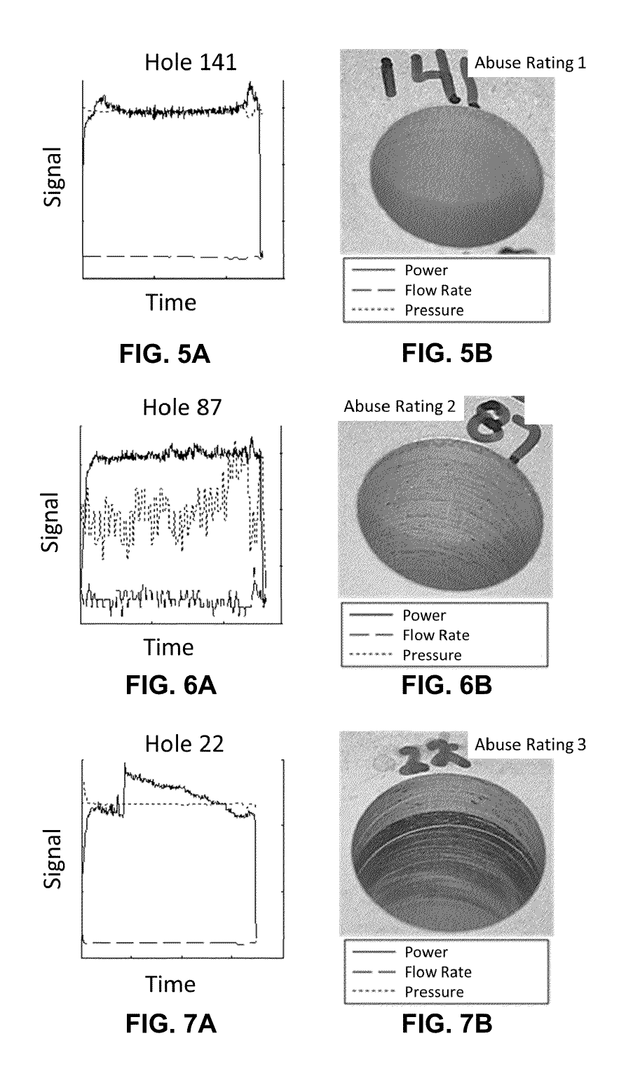

Then, controller 30 determines a quality of the machined feature in workpiece 24 based on the monitored horsepower (48). For example, controller 30 may determine a quality of the machined feature in workpiece 24 based on maximum horsepower, variation between maximum and minimum horsepower, along with frequency of horsepower variation of spindle 26. Example horsepower signals indicative of white layer damage are illustrated in FIGS. 5A-7B. If the quality of the machined feature in workpiece 24 is not acceptable, controller 30 may automatically reworking the feature with machine tool 23 based on the determination of the quality of the feature by returning to step 44. Alternatively, or in addition to automatically reworking the feature with machine tool 23, controller 30 may automatically store an indication that the machined feature in workpiece 24 is outside a predetermined tolerance range. The indication of the quality of the feature may include an indication the feature may include white layer damage.

Controller 30 also stores an indication of the quality of the feature in combination with a unique identifier for the feature in a non-transitory computer-readable medium (46). Controller 30 may also present the indication of the quality of the feature to a human operator via a user interface of controller 30 or via a network connection to a remote computing device.

In some examples, as part of machining the feature in workpiece 24, controller 30 may send control signals to machine tool 23, the control signals being based on a predetermined design of the feature and the monitored horsepower. For example, controller 30 may operate to adjust the feed rate of spindle 26 and/or rotational speed of spindle 26 based on the monitored operational parameters in order to keep the monitored operational parameters within predefined limits. For example, controller 30 may operate to adjust the feed rate of spindle 26 and/or rotational speed of spindle 26 to prevent the monitored horsepower of spindle 26 from exceeding a predefined limit.

### Experimental Results

FIGS. 5A-7B illustrate monitored horsepower and cooling fluid flow rates during the machining of different holes in combination with the machined holes. In particular, FIG. 5A illustrates the horsepower and cooling fluid flow rates for machined hole 141, which is illustrated in FIG. 5B. Machined hole 141 presents an acceptable surface free of white layer damage and other defects.

In contrast, FIG. 6A illustrates the horsepower and cooling fluid flow rates for machined hole 87, which is illustrated in FIG. 6B. Machined hole 87 presents a surface of moderate white layer damage. Machined hole 87 may be slated for rework in order to improve the surface quality of machined hole 87.

Likewise, FIG. 7A illustrates the horsepower and cooling fluid flow rates for machined hole 22, which is illustrated in FIG. 7B. Machined hole 22 presents a surface of excessive levels of white layer damage. Machined hole 22 may be slated for rework in order to improve the surface quality of machined hole 22, or potentially require scrapping the component including machined hole 22 if machined hole cannot be reworked to provide an acceptable surface within specified dimensional tolerance limits.

Comparison of the curves of FIGS. 5A, 6A and 7A illustrates the repeatable correlation between white layer damage and spindle horsepower and cooling fluid flow rates. While each of holes 141, 87 and 22 were machined according to the same specifications, using the same system, tooling and feedrates, as shown best in FIG. 7A, the maximum horsepower of the spindle varies according to the white layer damage in that higher horsepower of the spindle corresponds to increase severity of white layer damage. Likewise, as shown best in FIG. 6A, increased variability of horsepower also indicates white layer damage. Similarly, as shown in FIG. 6A, highly variable cooling flow rates and pressures represent a separate indications of white layer damage.

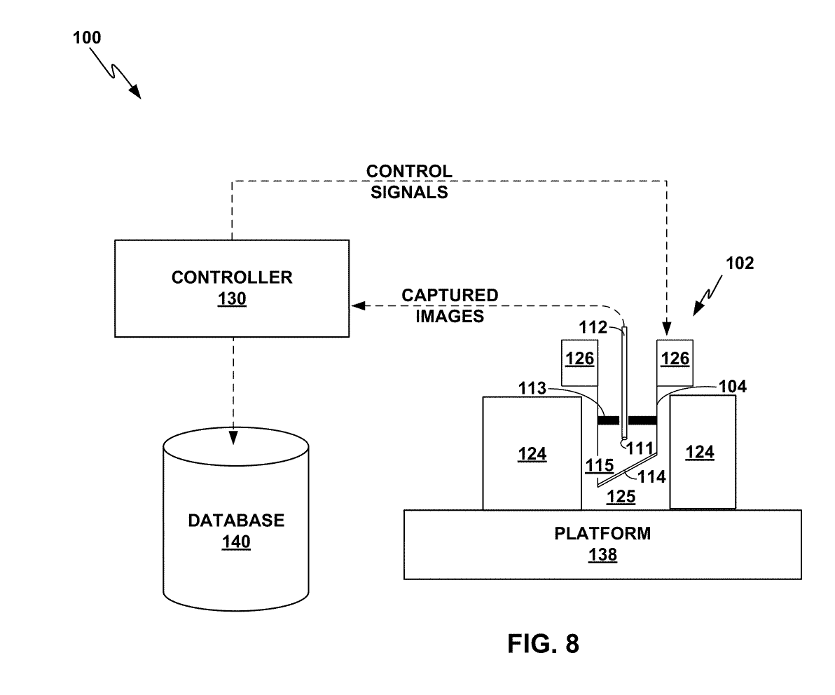

FIG. 8 illustrates system 100. System 100 includes an imaging device 102, controller 130 and database 140. Imaging device 102 includes camera 112, which may be a fiber optic camera. Camera 112 is mounted within tool sleeve 104 and supported by support structure 114 within tool sleeve 104. Mirror 114 is located at the bottom of tool sleeve 104 and functions to reflect light that passes through aperture 115 onto the lens and/or image sensor 111 of camera 112. Tool sleeve 104 including camera 112 is mounted within chuck 126. Chuck 126 which allows computer controlled positioning and rotation of camera 112 to facilitate capturing images of machined features in a component, and may be substantially similar to a CNC chuck.

As shown in FIG. 8, component 124 is mounted to platform 138 to facilitate capturing images of machined surfaces of component 124 with imaging device 102. In particular, imaging device 102 is located within through-hole 125 within component 124 in order to capture images of the machined surfaces of through-hole 125. In some examples, platform 138 may be the same as platform 38 such that images of machined surfaces of a workpiece or component may be captured at a common workstation immediately after machining the workpiece or component. In other examples, a machined component may be positioned on platform 138 after a machining operation for inspection.

Controller 130 represents a computing device configured to operate imaging device 102. Imaging device 102 is configured to capture images of component 124 in response to the control signals sent from controller 130. In some particular examples, controller 130 may include multiple computing devices that combine to provide the functionality of controller 130 as described herein. For example, controller 130 may comprise a CNC controller that issues instructions to chuck 126 and positioning actuators of chuck 126 as well as a separate computing device that controls camera 112 and determines a quality of a machined feature in a component based on an image of the component. In some examples, such a computing device may represent a general purpose computer running software. In the same or different examples, all or a portion of controller 130 may be part of controller 30.

Controller 130 determines a quality of a machined feature in component 124 based on images of machined surfaces of component 124. In some examples, machined features of component 124 may be subjected to an etchant prior to imaging with camera 112. The etchant will produce a dark coloring if swept grains and/or white layer has been produced to better facilitate the imaging analysis. For example, controller 130 may compare images of machined surfaces of component 124 to a database of previous images and based on a “best fit” a quantitative measure of etch response is assigned. In some examples, in-situ drilling conditions, such has horsepower or coolant pressure, as described above with respect to FIGS. 3-7 may be used as supplemental information to aid in the assessment of the quality of the surface of component 124. In additions, controller 130 may also use the images and in-situ drilling conditions to evaluate tool wear, such as evaluate the remaining number of holes that can be drilled with the specific bit before the risk of white layer damage becomes unacceptable.

While controller 130 may implement one or more of a variety of techniques to determine a quality of a machined feature in component 124, in some examples, controller 130 may implement one or more machine learning algorithms, such as Principle Component Analysis (PCA), Bayesian Belief Networks (BBN), k-Nearest Neighbor Learners (kNN) and/or Majority Learners (ML). Controller 130 may determine the quality of a hole, such as hole 125 based on training data that is provided both prior to the inspection of hole 125 and other machined components as well as additional data added during the manufacturing of a series of components. Visual inspection by a technician and microscopic material reports may be used to provide baseline information to the machine learning algorithms.

Controller 130 may be connected to database 140, which includes a non-transitory computer-readable medium storing inspection information and/or the machine learning algorithms necessary to accurately assess the quality of hole 125 being inspected. In addition, controller may update database 140 with information derived during the inspection of hole 125, such as an indication of the quality of the feature in combination with a unique identifier for the feature.

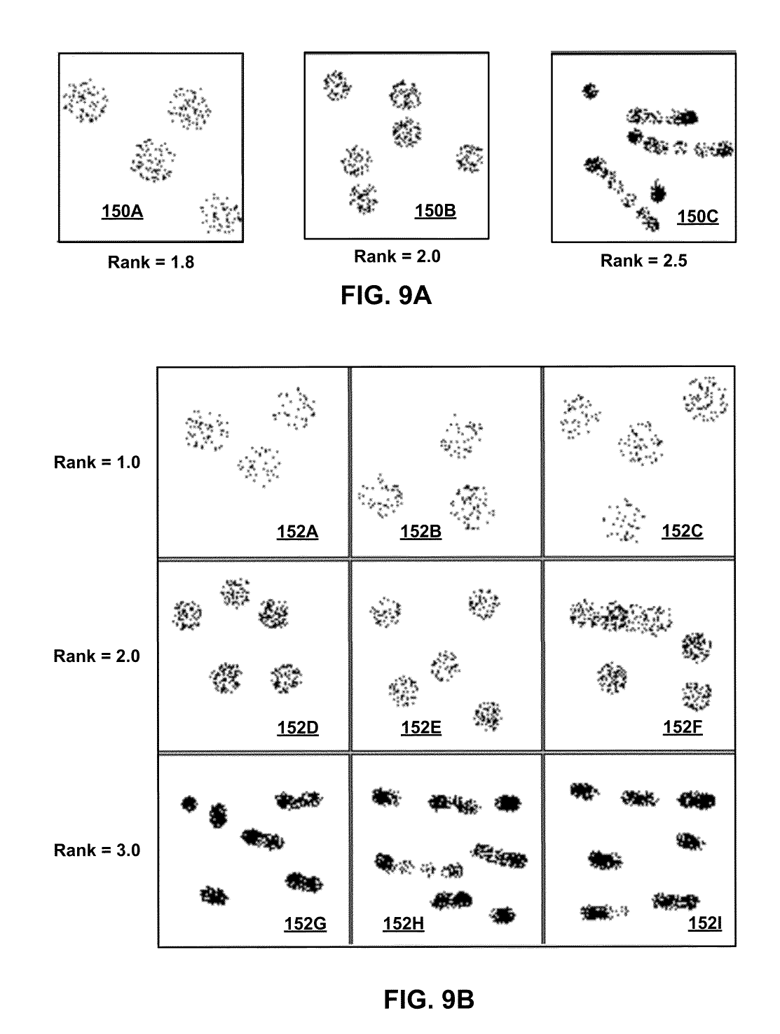

FIGS. 9A and 9B illustrate an example series of images that facilitate PCA of an image of a machined feature in a component to determine a quality of a machined feature based on the image. The image within a database that is the most similar to an input is automatically retrieved by a PCA search algorithm along with any other specific data associated with that particular image. Thus, PCA may be used to evaluate a captured image of a machined feature, such as a drilled hole.

Input images 150A-150C are illustrated in both FIG. 9A, whereas database images 152A-152I are illustrated in FIG. 9B. Database images 152A-152I are sorted into three rows. Database images 152A-152C in the first row represent a ranking of 1.0 for the purposes of this example. Similarly, database images 152D-152F in the second row represent a ranking of 2.0, and database images 152G-152I in the third row represent a ranking of 3.0.

In one simple example of PCA, as represented by FIG. 9A, input image 150A is first compared to each of database images 152A-152I using PCA to find the ranking of input image 150A as relative to the defined rankings of the database images. In this instance, based on relative similarities of input image 150A to database images 152A-152I using PCA, input image 150A is assigned a ranking of 1.8. Using the same techniques, input image 150B is compared to each of database images 152A-152I using PCA and assigned a ranking of 2.0, and input image 150C is compared to each of database images 152A-152I using PCA and assigned a ranking of 2.5.

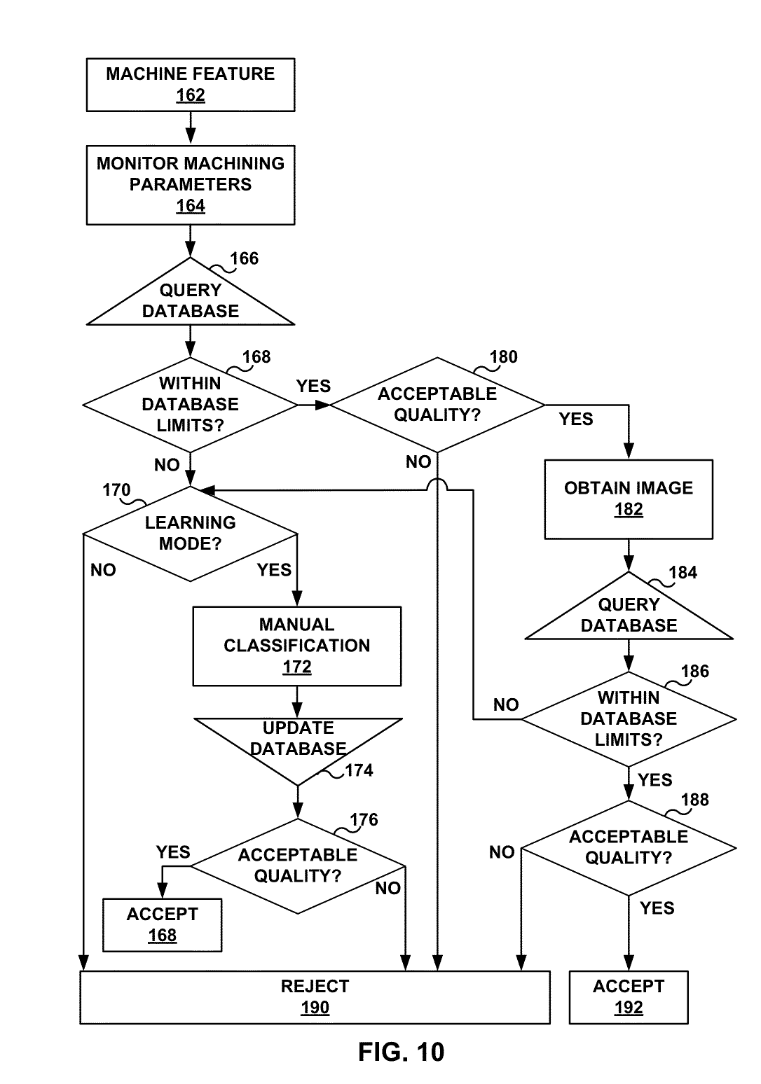

FIG. 10 is a flowchart illustrating example techniques for determining a quality of the machined feature in a component based monitored machining parameters and an image of the component. For clarity, the techniques of FIG. 4 are described with respect to system 20 of FIG. 3 and system 100 of FIG. 8.

Workpiece 24 is mounted to platform 38, and controller 30 initiates a machining operation with machine tool 23 on workpiece 24 to form a feature in workpiece 24 (162). During the machining of the feature into workpiece 24, controller 30 monitors machining parameters, of machine tool 23, such as the horsepower of spindle 26, vibrations and/or cooling fluid flow, (164). Then, controller 30 queries database 140 to compare the monitored parameters with the parameters within database 140 (166). Controller 30 determines whether the monitored parameters are within the range limits of parameters within database 140 (168).

If the monitored parameters are not within the range limits of parameters within database 140, and controller 30 is not in a learning mode (170), the machined feature is rejected (190). Following rejection, the machined feature may be reworked as described with respect to FIG. 4. If the monitored parameters are not within the range limits of parameters within database 140, during a learning mode (170), database 140 may be updated with the monitored parameters (174) following a manual classification of the machined features in workpiece 24 (172). For example, the manual classification of the machined features may include a visual inspection of the machined features. Updating database 140 may include updating the database to correlate the monitored parameters with the results of the manual classification. If, based on the manual inspection, the quality is acceptable, the machined feature may be accepted (168). If, based on the manual inspection, the quality is not acceptable, the machined feature may be rejected (190). Again, following rejection, the machined feature may be reworked as described with respect to FIG. 4.

If controller 30 determines that the monitored parameters are within the range limits of parameters within database 140 (168), controller 30 determines a quality of the machined feature in workpiece 24 based on the monitored machining parameters, such as horsepower (180). For example, controller 30 may determine a quality of the machined feature in workpiece 24 based on maximum horsepower, variation between maximum and minimum horsepower, along with frequency of horsepower variation of spindle 26. If the quality of the machined feature in workpiece 24 is acceptable, controller 30 may store an indication of the quality of the feature in combination with a unique identifier for the feature in a non-transitory computer-readable medium, such as database 140.

If the quality of the machined feature in workpiece 24 is not acceptable, controller 30 may automatically reworking the feature with machine tool 23 based on the determination of the quality of the feature. Alternatively, or in addition to automatically reworking the feature with machine tool 23, controller 30 may automatically store an indication that the machined feature in workpiece 24 is outside a predetermined tolerance range. Based on this indication, workpiece 24 may be indicated for further inspection, e.g., by system 100. Following the machining of workpiece 24, workpiece 24 may take the form of component 124.

Component 124 is positioned on platform 138 of system 100. In other examples, platform 138 may be the same as platform 38, such that component 124 does not have to be repositioned after machining prior to an imaging inspection. Controller 130 may obtain an image of a feature, such as hole 125 machined in a component 124, for example, by capturing an image with imaging device 102 (182). In some examples, all or a portion of controller 130 may be the same as controller 30. In some examples, machined surfaces of component 124 slated for inspection may be subjected to an etchant prior to imaging with camera 112 of imaging device 102. Then, controller 130 queries database 140 to compare the captured image with captured images within database 140 (184). Controller 130 determines whether the image of the feature is within the limits of database 140 such that a quality of the machined feature may be evaluated, for example, using PCA, as described with respect to FIG. 9 (186).

If the image of the feature is within the limits of database 140, and controller 30 is not in a learning mode (170), the machined feature is rejected (190). Following rejection, the machined feature may be reworked as described with respect to FIG. 4. If the image of the feature is within the limits of database 140, during a learning mode (170), database 140 may be updated with the captured image (174) following a manual classification of the machined features in workpiece 24 (172). For example, the manual classification of the machined features may include a visual inspection of the machined features. Updating database 140 may include updating the database to correlate the captured image with the results of the manual classification. If, based on the manual inspection, the quality is acceptable, the machined feature may be accepted (168). If, based on the manual inspection, the quality is not acceptable, the machined feature may be rejected (190). Again, following rejection, the machined feature may be reworked as described with respect to FIG. 4.

If controller 130 determines that the image of the feature is within the limits of database 140 (186), controller 130 determines a quality of a feature, such as hole 125, in component 124 based on the image of the feature (188). Based on this determination, the machined feature may either be accepted (192) or rejected (190). For example, controller 130 may determine a quality of a feature based on the image of the feature using PCA as described previously. Controller 130 may store an indication of the quality of the feature in combination with a unique identifier for the feature in a non-transitory computer-readable medium, such as database 140. Controller 130 may also present the indication of the quality of the feature to a human operator via a user interface of controller 130 or via a network connection to a remote computing device.

The techniques described in this disclosure may be implemented, at least in part, in hardware, software, firmware, or any combination thereof. For example, various aspects of the described techniques, including controller 30 and controller 130, may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer system-readable medium, such as a computer system-readable storage medium, containing instructions. Instructions embedded or encoded in a computer system-readable medium, including a computer system-readable storage medium, may cause one or more programmable processors, or other processors, to implement one or more of the techniques described herein, such as when instructions included or encoded in the computer system-readable medium are executed by the one or more processors. Computer system readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer system readable media. In some examples, an article of manufacture may comprise one or more computer system-readable storage media.

Various examples of this disclosure have been described. These and other examples are within the scope of the following claims.

What is claimed is:

1. A method comprising:
machining a component with a machine tool to form a feature in the component;
monitoring, by a computing device, while machining the feature into the component with the machine tool, horsepower of the machine tool used to machine the component;
determining, by the computing device, a quality of the feature in the component based on the monitored horsepower; and
storing, by the computing device, an indication of the quality of the feature in combination with a unique identifier for the feature in a non-transitory computer-readable medium.

2. The method of claim 1, further comprising sending control signals from the computing device to machine tool, the control signals being based on a predetermined design of the feature and the monitored horsepower, wherein the machine tool machines the component to form the feature in the component in response to the control signals sent from the computing device to the machine tool.

3. The method of claim 1, further comprising automatically reworking the feature with the machine tool based on the determination of the quality of the feature.

4. The method of claim 1, wherein the indication of the quality of the feature includes an indication the feature may include white layer damage.

5. The method of claim 1, wherein machining the component with the machine tool includes drilling into the component with a rotary element of the machine tool.

6. The method of claim 1, wherein the component comprises metal, wherein forming the feature in the component comprises forming the feature in the metal of the component.

7. A system comprising:
a machine tool; and
a computing device, wherein the computing device is configured to:
send control signals to the machine tool for causing the machine tool to machine a component to form a feature in the component,
monitor, while the machine tool machines the feature into the component, horsepower of the machine tool used to machine the component,
determine a quality of the feature in the component based on the monitored horsepower, and
store an indication of the quality of the feature in combination with a unique identifier for the feature in a non-transitory computer-readable medium.

8. The system of claim 7, wherein the control signals from the computing device for causing the machine tool to machine the component are based on a predetermined design of the feature and the monitored horsepower, wherein the machine tool is configured to machine the component to form the feature in the component in response to the control signals sent from the computing device to the machine tool.

9. The system of claim 7, wherein the computing device is further configured to present the indication of the quality of the feature to a human operator.

10. The system of claim 7, wherein the computing device is further configured to send additional control signals to the machine tool to rework the feature based on the determination of the quality of the feature.

11. The system of claim 7, wherein the computing device is further configured to store an indication that the feature in the component is outside a predetermined tolerance range.

12. The system of claim 7, wherein the indication of the quality of the feature includes an indication the feature may include white layer damage.

13. The system of claim 7, wherein the machine tool is configured to machine the component in response to the control signals from the computing device by drilling into the component with a rotary element of the machine tool.

14. A non-transitory computer-readable data storage medium having instructions stored thereon that, when executed by one or more processors of a computing device, cause the computing device to:
send control signals to a machine tool for causing the machine tool to machine a component to form a feature in the component;
monitor, while the machine tool machines the feature into the component, horsepower of the machine tool used to machine the component;
determine a quality of the feature in the component based on the monitored horsepower; and
store an indication of the quality of the feature in combination with a unique identifier for the feature in a non-transitory computer-readable medium.

15. The computer-readable data storage medium of claim 14, wherein the control signals from the computing device to machine tool are based on a predetermined design of the feature and the monitored horsepower.

16. The computer-readable data storage medium of claim 14, wherein the instructions stored on the computer-readable data storage medium, when executed by one or more processors of a computing device, further cause the computing device to send additional control signals to the machine tool to rework the feature based on the determination of the quality of the feature.

17. The computer-readable data storage medium of claim 14, wherein the instructions stored on the computer-readable data storage medium, when executed by one or more processors of a computing device, further cause the computing device to store an indication that the feature in the component is outside a predetermined tolerance range.

18. The computer-readable data storage medium of claim 14, wherein the indication of the quality of the feature includes an indication the feature may include white layer damage.

19. The computer-readable data storage medium of claim 14, wherein the control signals are for causing the machine tool to machine the component by drilling into the component with a rotary element of the machine tool.

20. The computer-readable data storage medium of claim 19, wherein the feature is a through hole.
